(19) United States
(12) Patent Application Publication
(10) Pub. No.: US 2007/0047083 A1
(43) Pub. Date: Mar. 1, 2007

(54) A REFLECTOR

(76) Inventor: Hungchen LEE, Taipei (TW)

Correspondence Address: BANGER SHIA, 204 CANYON CREEK, VICTORIA, TX, 77901-3695, US

(21) Appl. No.: 11/307,980

(22) Filed: Mar. 1, 2006

(30) Foreign Application Priority Data
Aug. 24, 2005 (CN) 200520063629.7

(51) Int. Cl. G02B 5/12

(52) U.S. Cl. 359/515

(57) ABSTRACT

The present invention provides a reflector typically comprising of a reflector strap and a main body, wherein, said reflector strap extends out one or more pins from the contacting surface with the main body, by connecting said pins to the coordinated holes of the main body in socket joint, said reflector strap is retained on the main body. The tight bond of reflector strap and the main body offered by the present invention guarantees the reflector nail use in normal and a longer service life.

### BACKGROUND OF THE INVENTION

1. Field of the Invention

The present invention relates to a road signal accessory, and more particularly to a reflector used on the surface of road.

2. Description of Prior Art

In accordance with a conventional technology, there are tow connection ways of locating the reflector strap 1′ on the main body 2′.

One is shown in FIG. 1, the reflector strap 1′ is bonded on the main body 2′ by ultrasonic welding, but after rolling out in a term, the weld seam is easy to be broken off by crushing so that the reflector strap 1′ falls off from the main body 2′ to be unusable, and the service life is cut down.

Another is shown in FIG. 2, the reflector strap 1″ is bonded on the main body 2″ by coating glue 3″, but after using a term, the bond line is easy to soak in water occurred by water entering, further to make glue 3″ no use, the reflector strap 1″ is fell off from the main body 2″ to be unusable, and the service life is cut down.

Therefore, how to solute the reflector strap falling off from the main body becomes a big problem to the manufacturers.

### OBJECTS AND SUMMARY OF THE INVENTION

It is therefore a main object of the present invention to provide a reflector that can efficiently prevent the reflector strap from falling off from the main body facilitating to guarantee the reflector nail use in normal and longer service life.

For archiving said goals, the present invention provides a reflector that is typically a reflector strap extending out one or more pins from the contacting surface with the main body, by connecting said pins to the coordinated holes of the main body in socket joint, said reflector strap is retained on the main body.

Wherein, the connection between the pins of said reflector strap and the holes of the main body is in interference fit, thereby the tight socket joint, the reflector strap is retained on the main body.

There is a beard formed on each pin of said reflector strap, thereby the beard catches upon the back rim of the hole of the main body, said reflector strap is retained on the main body. Said reflector strap possesses two or three pins formed on the back-contacting surface. Said tightly fit pins and holes are coated over glue so as to fasten the reflector strap on the main body more firmly.

Utilizing above-mentioned structure, the present invention takes the place of the conventional connection between the reflector strap and the main body with the socket joint—by the tight fit pins of the reflector strap and holes of the main body, the reflector strap is retained on the main body, and said socket joint is not affected by water soaking and vehicles rolling out, therefore, the reflector strap is bonded on the main body more firmly, meanwhile guarantee the reflector nail use in normal and a longer service life.

### BRIEF DESCRIPTION OF THE DRAWINGS

FIG. 1 is a scheme of the prior art.

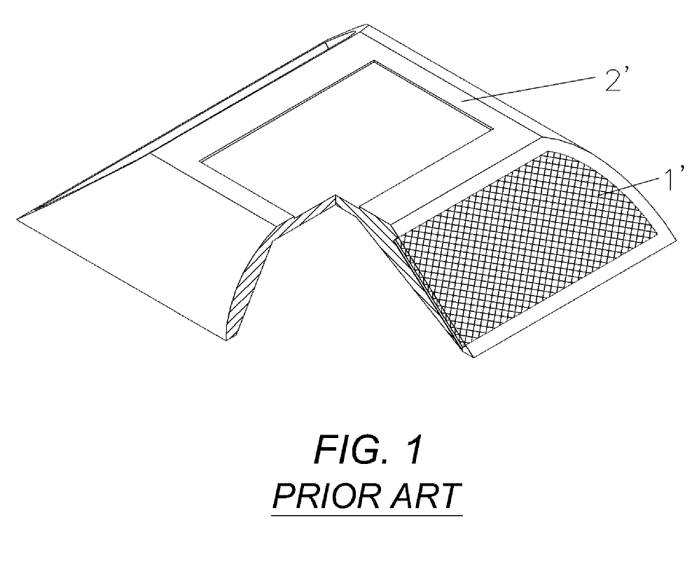

FIG. 2 is a scheme of another prior art.

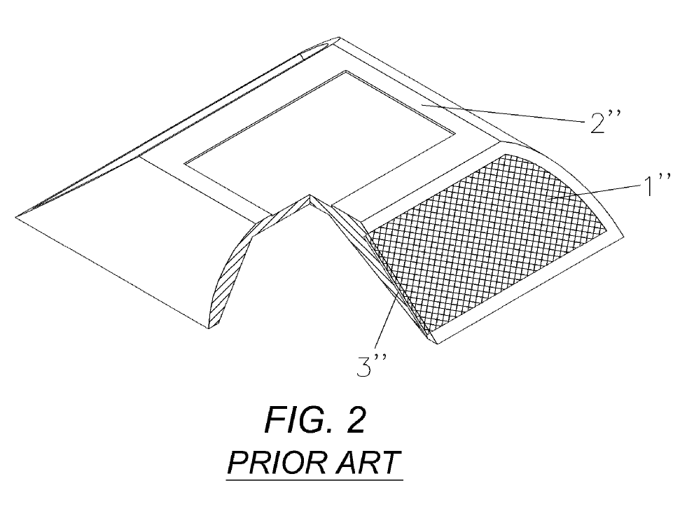

FIG. 3 is an exploded view showing the first embodiment of the present invention.

FIG. 4 is a sectional view showing combined first embodiment of the present invention.

FIG. 5 is an exploded view showing the second embodiment of the present invention.

FIG. 6 is a sectional view showing the combined second embodiment of the present invention.

### DETAILED DESCRIPTION OF PREFERRED EMBODIMENTS

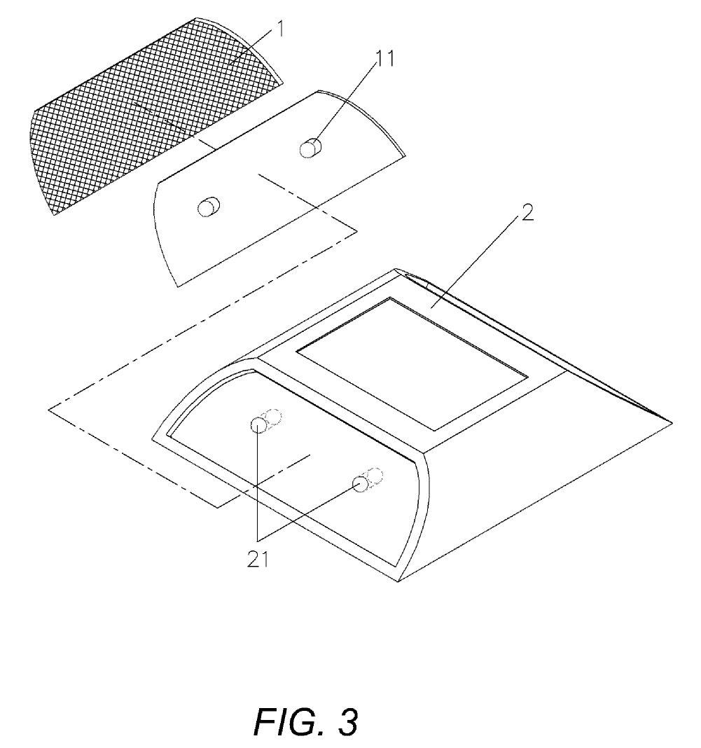

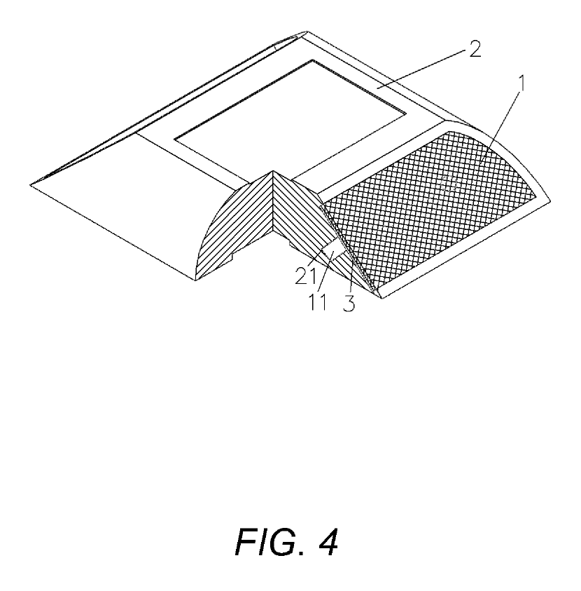

The first embodiment of the present invention is shown in FIG. 3 and FIG. 4, a reflector is typically a reflector strap 1 extending out one or more pins 11 from the contacting surface with the main body 2, the number of the pins depends on the necessary and design, in general, two or three are better, coordinating to pins 11 of the reflector strap 1, the corresponded blind holes 21 are formed on the main body 2, because the main body 2 is a solid block, so the depth of the blind hole 21 is designed to enough deep and is fit with the pin 11 in interference fit, so that the reflector strap 1 is retained on the main body 2. For making the connection firmer, coat glue 3 over the pin 111 and the blind hole 21 as fitting up.

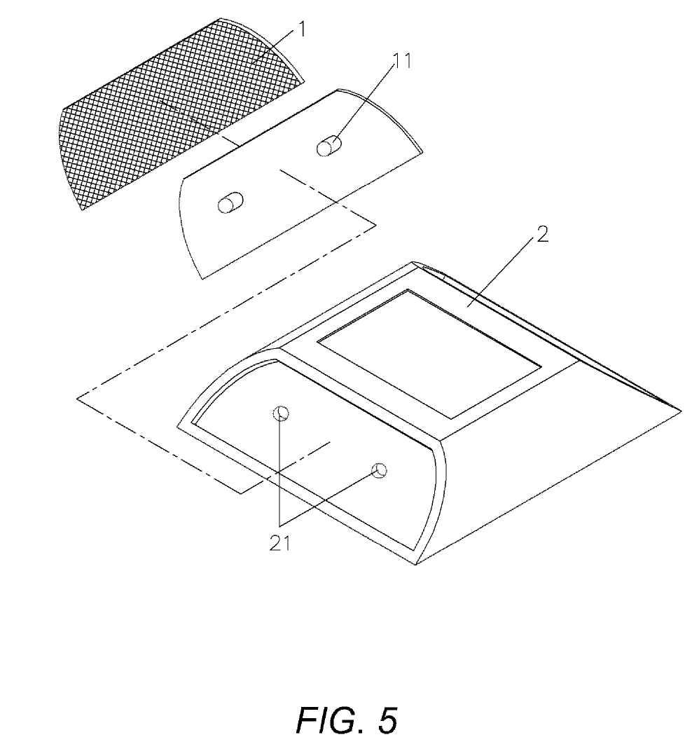

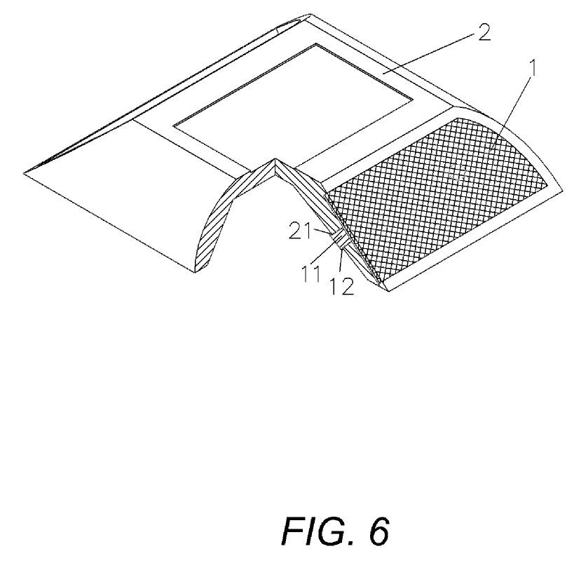

The second embodiment of the present invention is shown in FIG. 5 and FIG. 6, in which the reflector is a reflector strap 1 extending out more than one pin 11 (two pins are shown in drawings) on the contacting surface with the main body 2, coordinating to pins 11 of the reflector strap 1, the corresponded holes 21 are formed on the main body 2, because the main body 2 is a hollow block, the thinness of the side wall of the main body 2 is limited, so the contacting area of the pin 111 and said wall of the through hole 21 is limited too, for holding the pin 11 in, the tip end of the pin is thermo-compressed a beard 12 after passing through the through-hole 21, as same as rivet connection, thereby the beard 12 catching up the back rim of the through-hole 21, the reflector strap 1 is retained on the main body 2.

In brief, the present invention takes the place of the conventional connection between the reflector strap 1 and the main body 2 with the socket joint—by the tight fit pins 11 of the reflector strap 1 and holes 21 of the main body, the reflector strap 1 is retained on the main body 2, and said socket joint is not affected by water soaking and vehicles rolling out, therefore, the reflector strap 1 is bonded on the main body 2 more firmly, meanwhile guarantee the reflector nail use in normal and a longer service life.

What is claimed is:

1. A reflector typically comprising of a reflector strap and a main body, wherein, said reflector strap extends out one or more pins from the contacting surface with the main body, by connecting said pins to the coordinated holes of the main body in socket joint, said reflector strap is retained on the main body.

2. A reflector as claimed in claim 1, wherein the connection between the pins of said reflector strap and the holes of the main body is in interference fit, thereby the tight socket joint, the reflector strap is retained on the main body.

3. A reflector as claimed in claim 1, wherein there is a beard formed on each pin of said reflector strap, thereby the beard catches upon the back rim of the hole of the main body, said reflector strap is retained on the main body.

4. A reflector as claimed in claim 1, wherein said reflector strap possesses two or three pins formed on the back-contacting surface.

5. A reflector as claimed in claim 2, wherein said tightly fit pins and holes are coated over glue.
